(19) United States
(12) Patent Application Publication
(10) Pub. No.: US 2002/0122543 A1
(43) Pub. Date: Sep. 5, 2002

(54) System and method of indexing unique electronic mail messages and uses for the same

(76) Inventor: Chris E. Rowen, Bedford, NH (US)

Correspondence Address: SHAW PITTMAN LLP, 1650 TYSONS BOULEVARD, MCLEAN, VA, 22102, US

(21) Appl. No.: 10/072,988

(22) Filed: Feb. 12, 2002

Related U.S. Application Data
(60) Provisional application No. 60/268,092, filed on Feb. 12, 2001.
(60) Provisional application No. 60/347,278, filed on Jan. 11, 2002.

(51) Int. Cl. H04M 11/00

(52) U.S. Cl. 379/93.01

(57) ABSTRACT

A system and method of identifying unique email messages in a large scale enterprise environment using an external server and a database system. Message uniqueness is determined by assigning an message tag to each message based on properties of the email message. The message tag may be computed using a hashing algorithm to speed indexing and comparisons. The message tag is compared with an index file of message tags associated with pre-existing email messages. If a matching message tag is found in the index file, the email message is not unique. Otherwise, the email message is unique and the message tag is added to the index file. The system may include a relational database for storing the index file. An archiving system and method using the uniqueness checking feature of the present invention are also disclosed.

This application claims the benefit of U.S. Provisional Application No. 60/268,092, filed Feb. 12, 2001, and No. 60/347,278, filed Jan. 14, 2002, which are herein incorporated by reference in their entirety.

### BACKGROUND

1. Field of the Invention

The present invention relates generally to managing electronic mail messages and messaging systems. More particularly, the present invention relates to manipulation of messages extracted from an electronic mail messaging system.

2. Background of the Invention

Electronic mail (“email”) messaging systems have become core applications in many enterprises. In some organizations, an individual may send and receive only a few email messages on a typical day, while in other organizations, a typical user may send and receive many dozens of messages. Depending on the size of the organization, an email messaging system may process many hundreds or even thousands of messages every day. With both the number and size of messages and attachments growing at an astronomical rate, and with the escalating amount of business-critical information in the message store, managing email servers has become increasingly difficult. Overloading the capacity of email servers can impact backup and recovery performance, and may lead to loss of mission-critical information due to inadvertent deletion or mail server failure.

In some conventional email systems, the size of the message store may be controlled via certain thresholds, such as, for example, limitations on the number of messages that an individual mailbox may store, the cumulative size of messages stored in a mailbox, individual message sizes, the total number of messages that may be stored in the message store, and so on. These thresholds may be controlled by a system administrator, or in some cases they may be “hard-coded” into the email messaging application. A problem with such thresholds is that they serve to keep the message store within some pre-defined limits without actually providing any management capabilities to allow users to retain important messages for as long as they are needed.

Another method that has been used in the art to contain the size of the message store is to “archive” messages. Conventional message archiving systems have been embedded within email messaging applications. Because such systems are typically proprietary software applications, however, an email administrator may not have many options for how to archive and retrieve messages. Some systems may require that a system administrator must intervene when a user needs to retrieve an archived message. In other systems, the “archive” is merely a download of the messages to a user's local hard drive, which may not be readily accessible or searchable to retrieve an archived message.

In those email systems that do not include integrated archiving functionality, a system administrator may implement a manual archiving operation through email backup procedures. Backup procedures are typically designed to allow complete restoration of a message store (also known as the “post office”) in the event of a catastrophic failure. However, such backup procedures typically do not provide much of the functionality that is desirable for an archiving system. For example, in some backup procedures an email administrator may have to restore an entire post office just to retrieve one or more messages from an individual user's mailbox. An additional problem with typical backup procedures is that the email administrator may not be enabled to search the backup file for a particular message based on the contents of the message. Without a full text searching capability, it is more difficult to determine whether a particular email message has been archived.

To further complicate email administration, different organizations may have different email archiving requirements. For example, a “comprehensive” archival scheme may be required wherein the archiving process must be able to capture all messages in “real-time,” before a user has an opportunity to delete any messages. One way to perform a comprehensive archive is to intercept messages as they are sent or received and place copies of the messages into the archive. In this manner, a message may be captured and archived before it is distributed to all recipients. Accordingly, the archive file generally stores only a single copy of each archived message. This helps to reduce the size of the archive file.

In other organizations, the company's policy may not require a comprehensive archive, but instead a weekly or other periodic archiving process may be run. Such an archival process will not capture every message processed by the email system, but will only capture those messages on the system that have not been deleted by the time that the process is run. Unlike the real-time archival systems, messages are captured in a periodic archival system only after they have been distributed to individual recipients. Third-party, or external, periodic message archival systems operate essentially by reading all of the messages that are stored in each mailbox in the system. Every message that is read is then copied into the archive file. Archive files created by such conventional archiving systems become unnecessarily large because each mailbox is read independently of the others. Accordingly, messages sent to multiple mailboxes will appear to the archival process as distinct messages, resulting in duplicate messages being stored in the archive file. Although it would be possible for an archival system to archive only a single copy of each message if the archival system had access to the internal structure of the message store, such access is typically not granted to third parties due to the proprietary nature of the email systems.

A need therefore exists for a system and method for indexing unique email messages extracted from an email messaging system.

### SUMMARY OF THE INVENTION

The present invention provides a system and method for indexing unique email messages extracted from an electronic mail messaging system. The method includes the steps of reading a message from a mailbox on the electronic mail messaging system, where the message includes a plurality of message properties. Examples of message properties include a sender's name, a sender's submission time, a subject, and the like. The sender's name may be for example, an email address, if the originating email messaging system is an external messaging system, or a canonical name, if the email messaging system is the destination messaging system. The submission time preferably is based upon the submission time set by the originating email messaging system, and may, for example be expressed in microseconds.

The present invention then computes a unique identifier or Message Tag, which preferably comprises a string of data, using the message properties. For example, the sender's name and the sender's submission time may be used to compute the Message Tag. The Message Tag is stored in an index file associated with the message archive if the message is unique, that is, if the Message Tag is not already stored in the index file. If the Message tag already exists in the index file, the message is not unique.

To speed the process of determining whether or not a message is unique, a hashing algorithm may be applied to the Message Tag to obtain a “signature” of pre-determined length for the message. Accordingly, comparison of a newly computed Message Tag with Message Tags already stored in the index file will be faster due to the uniform length of the index records.

The present invention further comprises an archiving system and method wherein only unique messages are stored in a message archive.

### BRIEF DESCRIPTION OF THE DRAWINGS

FIG. 1 is a schematic diagram illustrating a method for computing a Message Tag in a first embodiment of the present invention.

FIG. 2 is a schematic diagram illustrating a method for computing a Message Tag in a second embodiment of the present invention.

FIG. 3 is a schematic diagram of an exemplary architecture for an embodiment of the present invention.

FIG. 4 is a flow diagram of steps for archiving email messages according to an embodiment of the present invention.

FIG. 5 is a schematic diagram illustrating components of a uniqueness checking system according to an embodiment of the present invention.

### DETAILED DESCRIPTION OF THE INVENTION

The present invention provides a system and method for indexing unique email messages extracted from one or more electronic mail messaging systems. The present invention further provides a system and method for archiving only unique messages extracted from a message store to minimize or prevent archiving multiple copies of the same electronic mail message.

The present invention uses an index file to store information about messages that have been previously extracted from an electronic mail messaging system. The index file may be stored using any suitable format allowing easy lookup and comparison for entries in the file. For example, the index file may be a text file, a spreadsheet, or a relational database table or set of tables. Whenever an email message is added to the archive, a “Message Tag” is generated and stored in the index file. The Message Tag is based on sufficient properties or attributes of an email message to create a unique identifier for each email message.

The systems and methods of the present invention may be used in any application in which it is desirable to identify duplicate messages in an email messaging system. For example, an email archiving application may advantageously incorporate the systems and methods of the present invention to reduce or minimize the size of a archive message store. If the invention is used in an archiving system, a temporary Message Tag is generated for the email message before the message is added to the archive. This temporary Message Tag is then compared with each Message Tag already stored in the index file. If the temporary Message Tag matches and existing entry in the index file, the email message has already been archived. In this case, the message need not be added to the archive.

The following sections describe two embodiments of the present invention. Each embodiment uses a different method to generate (or compute) the Message Tag for email messages.

First Embodiment

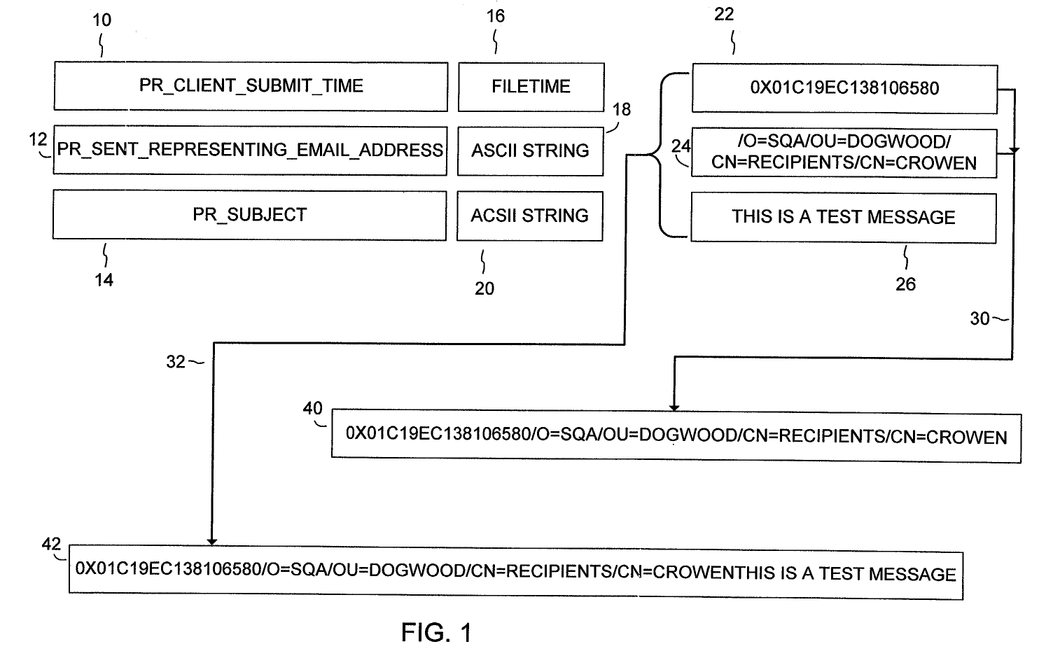

A first embodiment of the present invention is described with reference to FIG. 1. In this embodiment, the Message Tag may be computed by concatenating selected message properties to form a single text string. For example if the email messaging system is a Microsoft Exchange system, the messages may comprise properties such as PR_Client_Submit_Time in box 10, PR_Sent_Representing_Email_Address in box 12, and PR_Subject in box 14. Boxes 16, 18, and 20 show the corresponding data type associated with each of these properties. Boxes 22, 24, and 26 show an example of actual values that these properties may have for a particular message. For example, the value for PR_Client_Submit_Time in box 10 is shown in box 22 as “0x01c19e138106580.” The submission time in this example represents the time the message was submitted by the sender of the message. The format for the time is as generated by the system clock on the sender's email messaging server. The format for the submission time is not important as long the format is standardized for each server. That is, the same time format should be used to compute a Message Tag for all messages received from a particular server.

Box 24 contains “/o=sqa/ou=dogwood/cn=Recipients/cn=Crowen, which is the value of the Exchange property PR_Sent_Email_Address in box 12. This property is commonly referred to in the art as the sender's “fully qualified name.” A Message Tag generated based on the sender's submission time and the sender's fully qualified name will be sufficient for uniquely identifying most email messages. The values are concatenated (as illustrated in link 30) to yield Message Tag 40.

As described above, using the submission time and the sender's name is usually sufficient to uniquely identify an email message. However, to increase the likelihood that the Message Tag represents a unique message, other properties may be added to the string. For example, the PR_Subject property in box 14 may be included as shown in FIG. 1. In this example, the value of this property is “This is a test message,” as shown in box 26. In link 32, all three properties are concatenated to form Message Tag 42.

The above-described method for generating a Message Tag may be modified in many ways without departing from the spirit of the invention. For example, the concatenation order may be altered such that the resulting Message Tag is formed by concatenating the submission time string to the sender's name string. Alternatively, the subject may precede the sender's name, or the submission time, and so on. In another variation, the sender's name may comprise other properties to identify the sender of the email message. For example, the sender's name may be expressed as an Internet email name, such as “JDoe@acme.com.” This value would then be used as described above. Moreover, the Message Tag may be generated without using any sender information based upon other message properties, such as message size, header information, and the like.

Message Tags generated according to this embodiment will be of varying length. That is, a Message Tag for a first message extracted from an electronic mail messaging system may not be the same length as the Message Tag for a second message extracted from the electronic mail messaging system. Particularly, this is so because the sender's name and the email message subject fields may be of differing lengths. Moreover, different email messaging systems may use different implementations to compute the submission time. Due to the variable length of the Message Tag, searching through the index file may be a lengthy operation if the index file is very large. The second embodiment, described below, provides an enhanced Message Tag that optimizes such searches.

Second Embodiment

In a second embodiment, the variable length Message Tag is converted to a Message Tag having a pre-determined length by applying a hashing algorithm. Hashing algorithms are commonly used in the art of cryptography to generate keys for encrypting messages. They are also used to generate an electronic “signature” for a message that may be used to verify the integrity of a message. Such signatures are also known as a “fingerprint” or “message digest” for the message. One principle behind such hashing algorithms is that it is “computationally infeasible” to apply the algorithm to two different messages and get the same result. Another principle of hashing algorithms is that the resulting message digest will have a uniform length. It is this second principle that is useful in the context of the present invention. That is, if different Message Tags, generated as described above, are run through a hashing algorithm, the resulting Message Tags will have a uniform length and will still represent a unique email message.

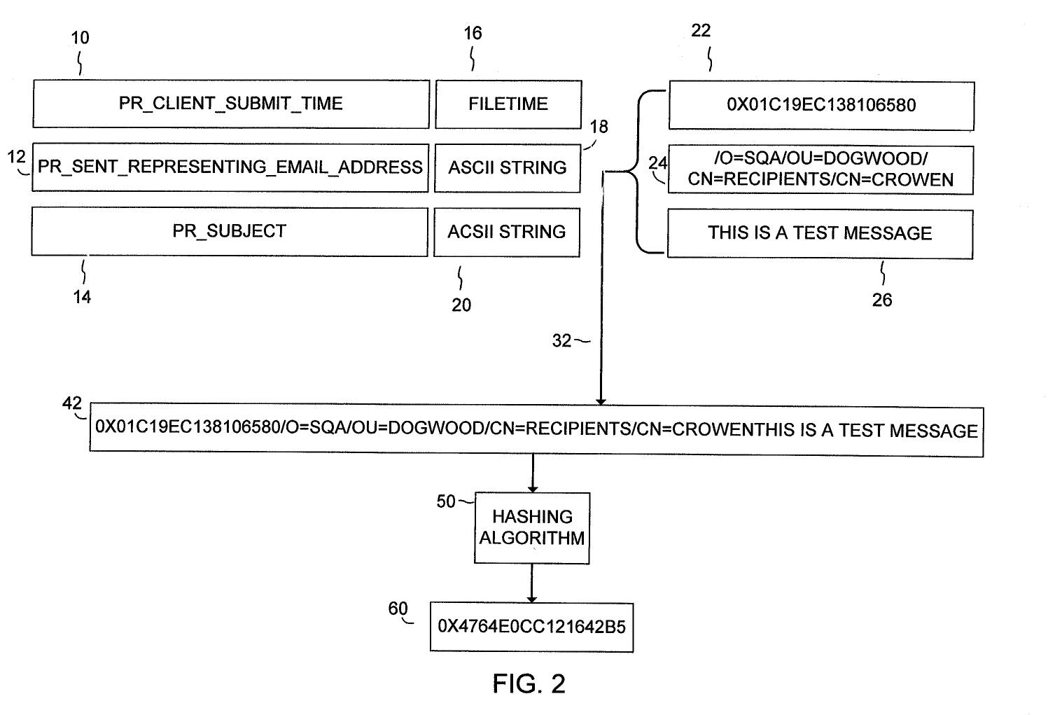

FIG. 2 is a schematic diagram illustrating the operation of the second embodiment of the present invention. Items numbered 10-42 are as described in connection with FIG. 1, above. Message Tag 42 is generated by concatenating the selected properties to form a variable length string, such as that described with reference to FIG. 2. This string is then used as an input to hashing algorithm 50. In this example, the output of hashing algorithm 50 is a 64-bit number, represented by the hexadecimal string: “0x4764e0cc121642b5,” shown in box 60. As known in the art, such a string ultimately represents a set of sixty-four bits (“1s” and “0s”) which may be converted to many different representations.

By generating Message Tags having a uniform length, the performance for lookup and compare operations on the index file can be greatly improved. In a preferred embodiment, the well-known “MD5” hashing algorithm is used. The MD5 hashing algorithm is defined in RFC 1321, www.faqs.org/rfc1321.html, which is incorporated herein by reference in its entirety. A Message Tag generated using the MD5 hashing algorithm will have a uniform length of 128-bits (i.e., sixteen characters (if converted to ASCII characters) or thirty-two hexadecimal numerals).

Architecture

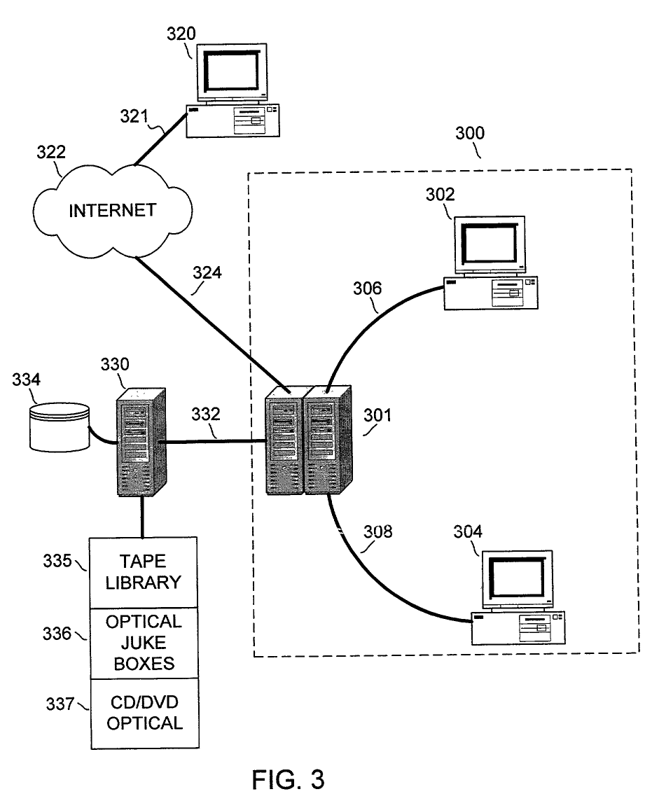

FIG. 3 shows an architecture that may be used to implement embodiments of the present invention. Enterprise email messaging system 300 includes email server 301 providing email services to clients 302 and 304. Email messaging system 300 may be a Microsoft Exchange server and communications between archive server 330 and email messaging server 300 may be processed via the well-known message application programming interface (MAPI) protocol. As known in the art, MAPI is a messaging architecture and a client interface component. As a messaging architecture, MAPI enables multiple applications to interact with multiple messaging systems across a variety of hardware platforms. As a client interface component, MAPI is the complete set of functions and object-oriented interfaces that forms the foundation for the MAPI subsystem's client application and service provider interfaces. In comparison with Simple MAPI, Common Messaging Calls (CMC), and the CDO Library, MAPI provides the highest performance and greatest degree of control to messaging-based applications and service providers.

Alternatively, email messaging system 300 may be a Lotus Notes mail server and communications may be processed via the Lotus Notes application programming interface (API) protocol. Similarly, if the email messaging system is a simple mail transfer protocol (SMTP) mail server, the communications may be processed via SMTP.

In the example shown in FIG. 3, communications links 306 and 308 may use MAPI, SMTP, or some other protocols, depending on the client systems' 302 and 304 capabilities. Email may be received from external system 320 via through Internet 322 via SMTP over communications link 321. In one embodiment of the present invention, archive server 330 initiates an archive session with email server 301 via communications link 332 on a periodic basis. The periodic basis may be, for example, daily, weekly, monthly, or some other appropriate interval of time, depending on the enterprise's archiving requirements. Communications link 332 may use any suitable network protocol, for example, the well-known transmission control/internet protocol (TCP/IP). In another embodiment of the present invention, archive server 330 retrieves emails in real time or near real-time.

As is known in the art, email messaging server 301 may comprise a plurality of mailboxes, directories, folders, or other “storage compartments” used to associate messages with individual users. As used herein, the term “mailbox” means the set of messages associated with a particular user including, where applicable, any subfolders or directories created by the user to organize his email messages. In some embodiments, a mailbox may comprise an “inbox” for storing newly arrived email messages and an “outbox” for storing messages sent by a user.

In one embodiment in which archive server 330 extracts messages on a periodic basis, archive server 330 reads every message in every mailbox on email server 301. In another embodiment, archive server 330 may be configured to read only new messages that were created or delivered since the last periodic session completed (or was initiated). In another embodiment, archive server 330 may be configured to read only messages in the inbox and outbox of the mailbox. Regardless of the message reading scheme implemented, the archive server checks an index file to determine the uniqueness of the message.

The “uniqueness checking” function may be integrated within archive server 330 or may be performed on a different server. In either case, the uniqueness checking function includes computation of a Message Tag, as described above. The Message Tag for a newly read message is compared with an index file on database 334. The index file comprises a list of Message Tags corresponding to all messages stored in a message archive on database 334. If the computed Message Tag matches an item in the index file, then the message is not unique. That is, the message has already been stored in the message archive and does not need to be stored a second time. Otherwise, if the computed Message Tag does not match any records in the index file, the message is unique and should be stored in the message archive. In this case, the Message Tag is also added to the index file.

Once messages have been archived on archive server 330, the data may be moved to other storage media without impacting the performance of email server 301. For example, the data may be moved to tape library system 335, optical jukeboxes 336, CD/DVD optical devices 337, and the like. By moving the archived data to such storage media, the organization may be able to reduce its long term storage costs because these media are less expensive than other magnetic storage media.

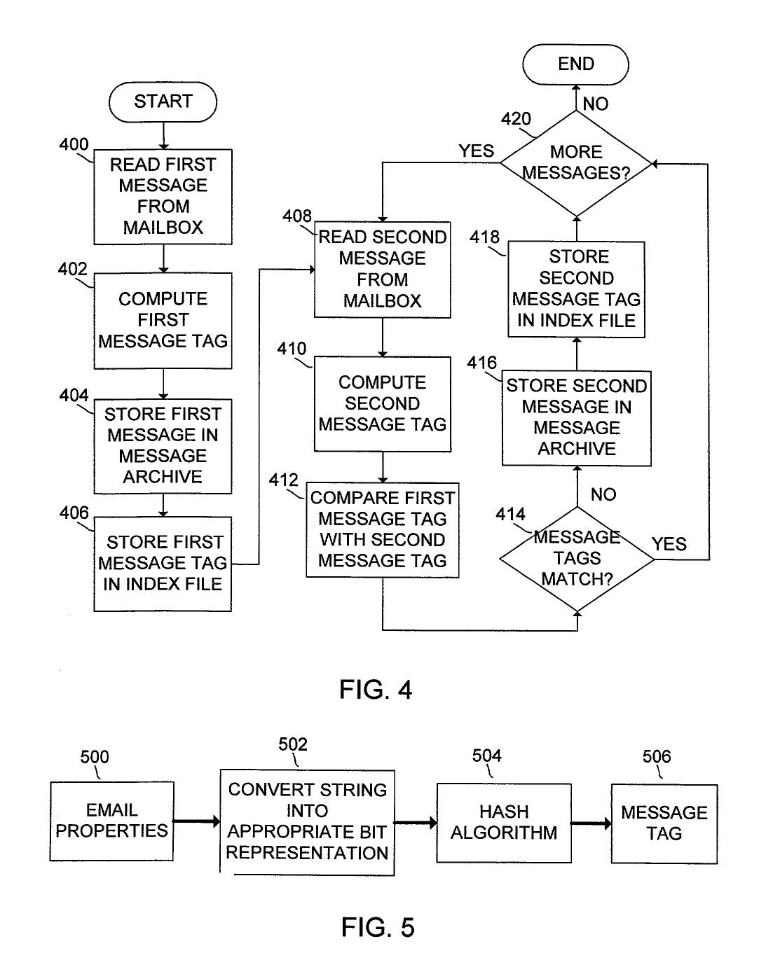

FIG. 4 is a flow diagram illustrating steps to archive email messages in an embodiment of the present invention. Steps 400-406 are initialization steps and are shown for clarity. That is, once a message archive and index file are populated, the process performs steps 408-420. In step 400, a first message is read from a mailbox on the email messaging server. In step 402 the Message Tag is computed for the first message and in step 404, the first message is stored in the message archive. In step 406, the computed Message Tag for the first message is stored in the index file. In step 408, a second (or next) message is read from a mailbox on the email messaging server. The mailbox may be the same mailbox from which the first message was read or may be a different mailbox. In step 410, the Message Tag for the second message is computed and in step 412, the second Message Tag is compared to the first Message Tag (i.e., the second Message Tag is compared with any Message Tags already stored in the index file).

In step 414, the process branches, depending on the results of step 412. If the second Message Tag matches the first Message Tag (i.e., if the second Message Tag is already in the index file), then the second message is not unique and the process moves on to step 420. If the message is unique (i.e., the Message Tag did not match any items in the index file), then the second message is stored in the message archive in step 416 and the second Message Tag is stored in the index file in step 418.

In step 420, the process checks to see if there are more messages to be read from the email messaging server. If there are more messages, then the process returns to step 408 to read the next message. Otherwise, if there are no more messages, the process ends.

FIG. 5 is a schematic diagram showing how a Message Tag may be computed in a second embodiment of the invention. In FIG. 5, email message properties 500 are selected from the email message. As described herein, the combination of the sender's name and submission time may be sufficient in most applications to uniquely identify an email message. The selected properties are combined to form a single string. The string may or may not include blank spaces. The string is converted into an appropriate bit representation in box 502. In box 504, the hash algorithm is applied to the bit-string to determine the Message Tag in box 506.

As described herein, the present system and method of archiving and retrieving email messages may be used in a large scale enterprise environment using a dedicated archiving server and a database system such as SQL or ORACLE™ brand. Alternatively, the archiving server may be on the same platform as the email messaging server. As described above, email messaging server may be based on any suitable email messaging protocol, for example, Microsoft OUTLOOK™, Lotus NOTES™, or proprietary or non-proprietary email messaging system.

Embodiment Including an Application Program

An embodiment of the present invention also comprises an application program itself as recorded in any magnetic or electronic media, and a computer system programmed with this program. In this embodiment, a computer system so programmed is configured to traverse mailboxes on an email messaging server to identify messages to be added to an archive. Such a program may operate to process messages delivered to the email messaging system before the program of the invention is executed. In this manner, the program identifies and extracts existing email messages for archive. The program may also be configured to archive messages in real-time, that is, as messages are processed by the email messaging system, a copy is retrieved by the archive server for archive processing.

Embodiments of the invention may include an embedded relational database to support high speed searching of message metadata. In such embodiments, keywords or the full text of messages are added to a message index file for rapid searching of messages. Additionally, the contents of certain attachments may be added to the message index. For example, attachments that are based on common word processing applications may be read by the archiving server to enable full-text searching on these attachments.

The present invention provides a comprehensive solution for externally archiving email messages from an email messaging system. The invention may be used by organizations that are obligated to maintain email messages for extended periods of time. For example, in certain financial organizations, the Federal Securities and Exchange Commission (SEC) has mandated that all records, including email messages, must be archived for a period of five years. The records must be stored in manner that allows individual records to be retrieved upon request. By storing email messages in an external archive, together with a full-text searching capability messages an implementation of the present invention may solve these and other requirements. Moreover, by checking for duplicate messages, the size of the archive message store may be kept at manageable levels.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method for identifying a unique electronic mail message in a plurality of electronic email messages extracted from an electronic mail messaging system, the method comprising:
retrieving a message from a mailbox on the electronic mail messaging system, the message including a plurality of message properties;
computing a message tag from at least a portion of the plurality of message properties;
reviewing a list of message tags stored in an index file; and
determining whether the message is unique based upon whether the message tag is found in an index file.

2. The method of claim 1, wherein the message tag is computed by concatenating at least two properties selected from the plurality of message properties.

3. The method of claim 2, wherein the message tag is further computed by applying a hash algorithm to the message tag to form a uniform string, wherein the uniform string has a predetermined length.

4. The method of claim 3, wherein the hash algorithm is an MD5 hash algorithm.

5. The method of claim 1, wherein the plurality of message properties includes a sender's name and a sender's submission time, and wherein the message tag is computed by concatenating the sender's name to the sender's submission time.

6. The method of claim 1, wherein the plurality of message properties includes a sender's name, a sender's submission time and a subject, and wherein the message tag is computed by concatenating the sender's name and the subject to the sender's submission time.

7. The method of claim 1, wherein the index file is stored in a relational database system.

8. A method for archiving a plurality of electronic mail messages in a system external to an electronic mail messaging system, the method comprising:
reading a first message from a first mailbox on the electronic mail messaging system, the first message including at least a first sender's name and at least a first sender's submission time;
computing a first message tag from the first sender's name and the first sender's submission time;
storing the first message in a message archive and storing the first message tag in an index file associated with the message archive;
reading a second message from a second mailbox on the electronic mail messaging system, the second message including at least a second sender's name and at least a second sender's submission time;
computing a second message tag from the second sender's name and the second sender's submission time;
comparing the second message tag with the first message tag; and
storing the second message in the message archive and storing the second message tag in the index file if the first and second message tags are not the same.

9. The method of claim 8, wherein the first message tag is computed by concatenating the first sender's name and the first sender's submission time to form a first message string and wherein the second message tag is computed by concatenating the second sender's name and the second sender's submission time to form a second message string.

10. The method of claim 9, wherein the first message tag is further computed by applying a hash algorithm to the first message string to form a first uniform string, wherein the first uniform string has a pre-determined length, and wherein the second message tag is further computed by applying the hash algorithm to the second message string to form a second uniform string, wherein the second uniform string has the pre-determined length.

11. The method of claim 10, wherein the hash algorithm is an MD5 hash algorithm.

12. The method of claim 8, wherein the first mailbox and the second mailbox are different mailboxes on the electronic mail messaging system.

13. The method of claim 8, wherein the index file is stored in a relational database system.

14. The method of claim 8, wherein the message archive is a relational database system.

15. A system for identifying a unique electronic mail message, wherein the system is external to an electronic mail messaging system, the system comprising:
means for reading an electronic mail message from a mailbox on the electronic mail messaging system, the electronic mail message including a plurality of message properties;
means for computing a message tag from a least two properties selected from the plurality of message properties;
means for comparing the message tag with a list of message tags stored in an index file; and
means for determining that the message is unique if the message tag is not in the index file.

16. The system of claim 15, wherein the at least two properties comprise a sender's name and a sender's submission time.

17. The system of claim 15, wherein the message tag is computed by concatenating the at least two properties to form a first message string.

18. The system of claim 17, wherein the message tag is further computed by applying a hash algorithm to the message string to form a uniform string, wherein the uniform string has a pre-determined length.

19. The system of claim 18, wherein the hash algorithm is an MD5 hash algorithm.

20. The system of claim 15, wherein the index file is stored in a relational database system.

21. A system for identifying a unique electronic mail message, wherein the system is external to an electronic mail messaging system, the system comprising:
a uniqueness checker in communication with the electronic mail messaging system; and
an index file comprising a plurality of pre-determined message tags,
wherein the uniqueness checker is configured to read a message from the electronic mail messaging system, wherein the message includes a plurality of properties associated with the message,
wherein the uniqueness checker computes a message tag for the message using at least two of the properties, and compares the computed message tag with the index file,
wherein if the computed message tag matches an entry in the index file, the uniqueness checker determines that the message is not unique, otherwise, if the computed message tag does not match an entry in the index file, the computed message tag is added to the index file.

22. The system of claim 21, wherein the message tag is computed by concatenating the at least two properties to form a message string.

23. The system of claim 22, wherein the message tag is further computed by applying a hash algorithm to the message string to form a uniform string, wherein the uniform string has a pre-determined length

24. The system of claim 23, wherein the hash algorithm is an MD5 hash algorithm.

25. The system of claim 21, wherein the uniqueness checker reads the message from a mailbox on the electronic mail messaging system.

26. The system of claim 21, wherein the plurality of properties comprises a sender's name and a sender's submission time.

27. The system of claim 26, wherein the plurality of properties further comprises a subject string, and wherein the message tag is computed by concatenating the sender's name, the sender's submission time, and the subject string to form a message string.

28. The system of claim 27, wherein the message tag is further computed by applying a hash algorithm to the message string to form a uniform string, wherein the uniform string has a pre-determined length.

29. The system of claim 15, wherein the index file is stored in a relational database system.

30. A system for archiving a plurality of electronic mail messages, wherein the system is external to an electronic mail messaging system, the system comprising:
means for reading a first message from a first mailbox on the electronic mail messaging system, the first message including at least a first sender's name and at least a first sender's submission time;
means for computing a first message tag from the first sender's name and the first sender's submission time;
means for storing the first message in a message archive and storing the first message tag in an index file associated with the message archive;
means for reading a second message from a second mailbox on the electronic mail messaging system, the second message including at least a second sender's name and at least a second sender's submission time;
means for computing a second message tag from the second sender's name and the second sender's submission time;
means for comparing the second message tag with the first message tag; and
means for storing the second message in the message archive and storing the second message tag in the index file if the first and second message tags are not the same.

31. The system of claim 30, wherein the first message tag is computed by concatenating the first sender's name and the first sender's submission time to form a first message string and wherein the second message tag is computed by concatenating the second sender's name and the second sender's submission time to form a second message string.

32. The system of claim 31, wherein the first message tag is further computed by applying a hash algorithm to the first message string to form a first uniform string, wherein the first uniform string has a pre-determined length, and wherein the second message tag is further computed by applying the hash algorithm to the second message string to form a second uniform string, wherein the second uniform string has the predetermined length.

33. The system of claim 32, wherein the hash algorithm is an MD5 hash algorithm.

34. The system of claim 30, wherein the first message further comprises a first subject string and the second message further comprises a second subject string, and wherein the first message tag is computed by concatenating the first sender's name, the first sender's submission time, and the first subject string to form a first message string, and wherein the second message tag is computed by concatenating the second sender's name, the second sender's submission time and the second subject string to form a second message string.

35. The system of claim 30, wherein the index file is stored in a relational database system.

36. The system of claim 30, wherein the message archive is a relational database system.

37. A system for externally archiving a plurality of electronic mail messages selected from an electronic mail messaging system, the system comprising:
an archive server in communication with the electronic mail messaging system;
a uniqueness checker in communication with the archive server; and
an archive message store in communication with the archive server,
wherein when the archive server reads a message from the electronic mail messaging system, a plurality of properties associated with the message are sent from the archive server to the uniqueness checker,
wherein the uniqueness checker computes a message tag for the message using at least two of the properties, and compares the computed message tag with an index file,
wherein if the computed message tag matches an entry in the index file, the uniqueness checker indicates to the archive server that the message is not unique, otherwise, if the computed message tag does not match an entry in the index file, the computed message tag is added to the index file,
wherein if the message is unique, the archive server stores the message in the archive message store.

38. The system of claim 37, wherein the message tag is computed by concatenating the at least two properties to form a message string.

39. The system of claim 38, wherein the message tag is further computed by applying a hash algorithm to the message string to form a uniform string, wherein the uniform string has a pre-determined length

40. The system of claim 39, wherein the hash algorithm is an MD5 hash algorithm.

41. The system of claim 37, wherein the archive server reads the message from a mailbox on the electronic mail messaging system.

42. The system of claim 41, wherein the plurality of properties comprises a sender's name and a sender's submission time.

43. The system of claim 42, wherein the plurality of properties further comprises a subject string, and wherein the message tag is computed by concatenating the sender's name, the sender's submission time, and the subject string to form a message string.

44. The system of claim 43, wherein the message tag is further computed by applying a hash algorithm to the message string to form a uniform string, wherein the uniform string has a pre-determined length.
